(19) United States
(12) Patent Application Publication
(10) Pub. No.: US 2002/0081491 A1
(43) Pub. Date: Jun. 27, 2002

(54) Battery apparatus and method of forming a battery apparatus

(76) Inventors: Oliver J. Gross, Round Rock, TX (US); Peter Guggenheim, Austin, TX (US)

Correspondence Address: HARNESS, DICKEY & PIERCE, P.L.C., P.O. BOX 828, BLOOMFIELD HILLS, MI, 48303, US

(21) Appl. No.: 09/989,941

(22) Filed: Nov. 21, 2001

Related U.S. Application Data
(60) Provisional application No. 60/250,277, filed on Nov. 29, 2000.

(51) Int. Cl. B23K 1/06; H01M 2/30; H01M 2/08

(52) U.S. Cl. 429/181; 228/110.1; 228/256; 29/623.2; 29/623.4; 429/161

(57) ABSTRACT

A battery apparatus includes an anode terminal and a cathode terminal at least one of which includes a conductive extension extending through and contacting insulative housing material. The extension includes at least one outer rough surface characterized by a plurality of surface nodules at least a majority of which are at least 5 microns in height and have a maximum linear cross dimension of at least 20 microns and which contact and bond with the enveloping electrically insulative housing material. The battery apparatus can include a plurality of bicells. A method of forming a battery apparatus includes brushing an outer surface of at least one of an anode terminal material or a cathode terminal material effective to roughen the outer surface from what it was prior to the brushing. The anode and cathode assembly are enveloped in a housing comprising electrically insulative material with at least the one terminal material projecting therefrom.

This application claims the benefit of U.S. Provisional Application No 60/250,277, filed Nov. 29, 2000.

### FIELD OF THE INVENTION

This invention relates generally to batteries, and to methods of forming batteries.

### BACKGROUND OF THE INVENTION

Batteries based on aqueous, non-aqueous and solid electrolytes are manufactured as power sources for microelectronic and portable electronic equipment. Size and weight are typically significant considerations in a design. Some designs include a plurality of thin layers which are laminated together. Some batteries include several electrolytic cells in which the current from each of the cells is accumulated in parallel by anode and cathode current collectors. In certain designs, the current collectors are gathered and welded to respective terminal strips. The battery components can be sealed or enveloped in a heat-sealable laminate which serve as the protective housing for the battery, with the welded terminal strips projecting therefrom for electrically engaging the battery.

It is highly desirable that the housing for the battery apparatus function as a hermetic seal to prevent internal battery material from exiting the housing, as well as to prevent external material from entering the housing. The locations where the collector electrode terminal strips project from the housing have proven to be the most difficult area within which to get an adequate hermetic seal of the heat-sealable laminate to prevent ingress and egress of material relative to the housing. This is due in part to a desired bond typically having to be created between two dissimilar materials, namely the housing package material and the typical metal of the terminal tab. Traditionally, this bond has been the weakest of all bonds in the packaging assembly.

It would be desirable to develop improved techniques for creating better seals where terminal strips for such batteries exit the housing. While the invention was principally motivated in seeking a solution to the stated objective, it is in no way so limited. The artisan will appreciate applicability of the invention to other aspects involving batteries, with the invention only being limited by the accompanying claims as literally worded and as appropriately interpreted in accordance with the doctrine of equivalents.

### SUMMARY

In one aspect of the present inventions a battery apparatus including an anode layer, a cathode layer, and an electrolyte operatively positioned therebetween is provided. The battery apparatus also includes a housing comprising electrically insulative material enveloping and sealed around the anode layer, the cathode layer and the electrolyte. Additionally included is an anode terminal electrically connected with the anode layer and a cathode terminal electrically connected with the cathode layer, the anode terminal and the cathode terminal being electrically accessible externally of the housing. At least one of the anode terminal and the cathode terminal has an electrically conductive extension extending through and contacting the electrically insulative housing material. The extension has a rough surface in contact with the electrically insulative housing material and the rough surface is shaped such that a complete seal continuously around the electrically conductive extension may be provided between the rough surface of the electrically conductive extension and the insulative housing material. A bond is also included which provides a complete seal continuously around the electrically conductive extension between the rough surface of the electrically conductive extension and the insulative housing material.

In another aspect of the present invention a battery apparatus including an anode layer, a cathode layer, and an electrolyte operatively positioned therebetween is provided. Also included is a housing comprising electrically insulative material enveloping and sealed around the anode layer, the cathode layer and the electrolyte. In addition, an anode terminal electrically connected with the anode layer and a cathode terminal electrically connected with the cathode layer is included. The anode terminal and the cathode terminal are electrically accessible externally of the housing. At least one of the anode terminal and the cathode terminal has an electrically conductive extension extending through and contacting the electrically insulative housing material. the extension has at least one outer rough surface including a plurality of surface nodules which contact and bond with the enveloping electrically insulative housing material, (i) at least a majority of the surface nodules, and/or (ii) at least 25 of the surface nodules within a 50,000 micron² area and/or (iii) an average of all surface discernable objects along any 500 micron length of the rough surface, have a height which is at least about 5 microns and having a maximum cross dimension which is at least 20 microns.

In another aspect of the present invention a method of forming a battery apparatus having an anode, a cathode and an electrolyte therebetween is provided. The method includes providing an outer surface of at least one of an anode terminal material and a cathode terminal material with a rough surface. Additionally included is the step of enveloping the anode, the cathode and the electrolyte in a housing comprising electrically insulative material. The step of extending at least one of the anode terminal material and the cathode terminal material through the housing such that the at least one terminal material projects therefrom is also included. Additionally included is the step of bonding the electrically insulative material to the rough surface by flowing the electrically insulative housing material onto the rough surface to form a complete seal between the rough surface of the terminal and the electrically insulative housing material.

In yet another aspect of the present invention a method of forming a battery apparatus having an anode layer, a cathode layer, and an electrolyte operatively positioned therebetween is provided. The method includes the step of enveloping the anode layer, the cathode layer and the electrolyte in a housing comprising electrically insulative material. Additionally included is the step of extending an anode terminal electrically connected with the anode layer and a cathode terminal electrically connected with the cathode layer through the housing such that at least one terminal material projects therefrom. Also included is the step of providing an outer surface of at least one of the anode terminal and the cathode terminal with a plurality of surface nodules such that, (i) at least a majority of the surface nodules, and/or (ii) at least 25 of the surface nodules within a 50,000 micron² area and/or (iii) an average of all surface discernable objects along any 500 micron length of the rough surface, have a height which is at least about 5 microns and have a maximum cross dimension which is at least 20 microns. In addition, the step of bonding the electrically insulative material to the rough surface is included.

### BRIEF DESCRIPTION OF THE DRAWINGS

Preferred embodiments of the invention are described below with reference to the following accompanying drawings.

FIG. 1 is a normal angle scanning electron microscopy photomicrograph of a portion of a prior art aluminum terminal strip for a battery apparatus comprising a plurality of bicells;

FIG. 2 is an oblique angle scanning electron microscopy photomicrograph of the FIG. 1 prior art aluminum terminal strip;

FIG. 3 is a normal angle scanning electron microscopy photomicrograph of a portion of an outer surface of terminal material in accordance with an aspect of the invention;

FIG. 4 is an oblique angle scanning electron microscopy photomicrograph of the FIG. 3 outer surface;

FIG. 5 is a diagrammatic top plan view of a battery apparatus in accordance with an aspect of the invention;

FIG. 6 is an enlarged diagrammatic sectional view taken through line 6-6 in FIG. 5;

FIG. 7 is an enlarged diagrammatic sectional view taken through line 7-7 in FIG. 5; and

FIG. 8 is a diagrammatic top plan view of the FIG. 5 apparatus in a state of manufacture subsequent to that shown by FIG. 5.

### DETAILED DESCRIPTION OF PREFERRED EMBODIMENTS

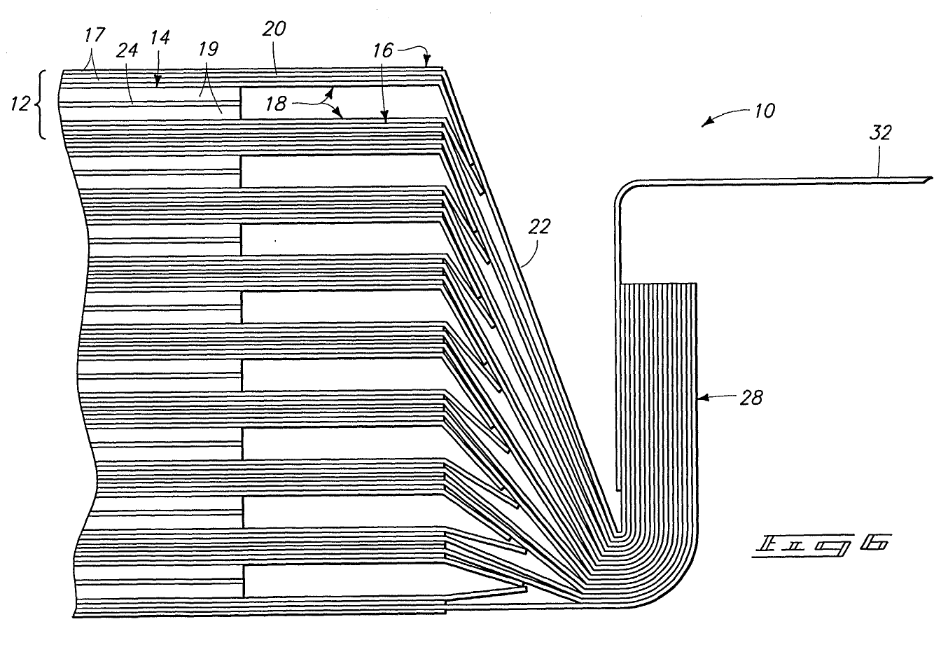

Referring initially to FIGS. 5-7, an exemplary battery apparatus in accordance with but one implementation of the invention is indicated generally with reference numeral 10. Such comprises a bicell construction wherein individual bicells 12 comprise two counter electrodes positioned on either side of an intermediate electrode. The depicted reduction-to-practice example includes a plurality of eight bicells, the individual construction of which is not particularly material to the invention but is briefly described for completeness. The particular illustrated example is an anode-out assembly comprising a central cathode construction 14 having a pair of anode counter electrodes 16 positioned outwardly thereof. Separators 18 are received intermediate the respective anode counter electrodes and the cathode.

The preferred anode of each bicell further comprises anode active material 17 (i.e., preferably a polymeric binder and a carbonaceous particulate material) which sandwiches an anode current collector 20. Collector 20 includes an integral extension 22. An example and preferred material for the anode collector is a copper mesh material. The preferred cathode of each bicell comprises a cathode active material 19 (i.e., preferably a lithium metal oxide) which sandwiches a cathode current collector 24 having an integral cathode current collector extension 26. An example and preferred material for the cathode current collector is an aluminum mesh material. The respective extensions are preferably in the form of same-sized tabs which overlap for the anode at a gathering 28 and for the cathode at a gathering 30. An anode terminal member 32 is welded with anode current collector extensions 22, and a cathode terminal member 34 is welded with cathode current collector extensions 26. In conjunction with the described preferred embodiment, anode terminal member 32 preferably comprises non-mesh copper, and cathode terminal member 34 preferably comprises non-mesh aluminum. Each has opposing top and bottom surfaces.

At least one of anode terminal member 32 and cathode terminal member 34 (preferably both) has at least one of its outer surfaces (preferably both) which is rough. The preferred outer rough surface includes a plurality of surface nodules. Preferably, (i) at least a majority of the discernable surface nodules; and/or (ii) at least 25 of the discernable surface nodules within a 50,000 micron² area; and/or (iii) an average of all discernable surface nodules along any 500 micron length of the outer rough surface; have a height (i.e., a peak to base distance) which is at least about 5 microns and have a maximum cross dimension (i.e., the linear cross dimension which is largest) of at least about 20 microns. More preferably, the surface nodules have a height which is from about 10 microns to about 25 microns; even more preferably from about 12 microns to about 20 microns; and most preferably from about 12 microns to about 15 microns. With respect to the maximum cross dimension of the surface modules, they preferably have a maximum cross dimension which is less than about 100 microns; more preferably, less than about 80 microns; and even more preferably from about 30 microns to about 80 microns.

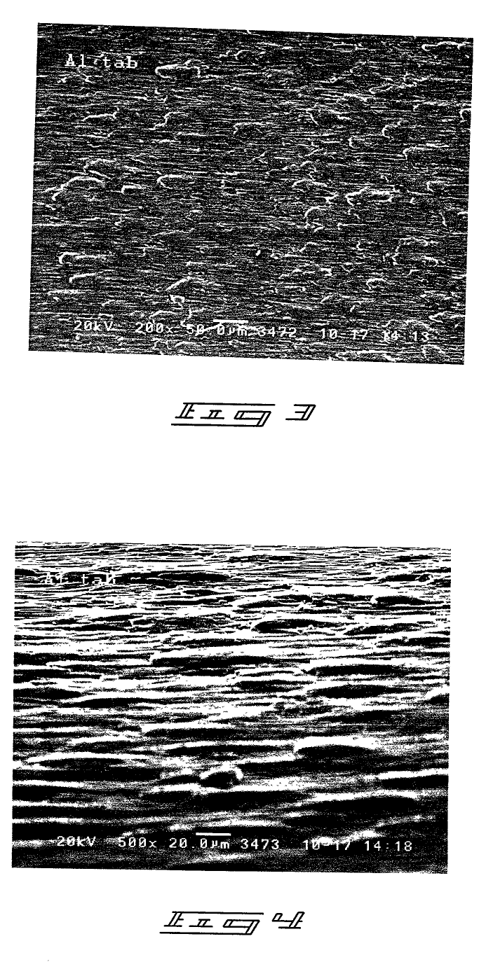

The term “discernable” surface nodules is used herein to distinguish between true surface nodules and normal imperfections consistent with those that might be seen in any similar surface, including those that would be perceived as smooth to one skilled in the art. Preferably, in identifying “discernable” surface nodules on the rough surface, scanning electron microscopy is utilized at 20 kV and at an oblique angle and enlarged 500 times as seen, e.g., in FIG. 2 (showing an example of the prior art) and in FIG. 4 (showing an example of the present invention).

In determining the average maximum cross-dimensions, there may be discernable surface nodules with a maximum cross dimension which is partially inside the 500 micron length of the surface and partially outside this length. If such surface nodules extend the entire 500 microns, that dimension (i.e., 500 microns) is utilized for that nodule in finding the average maximum cross dimension. If such surface nodules do not extend the entire 500 micron length, the length of their cross dimension as measured within the 500 micron length and that dimension is utilized for that nodule in finding the average maximum cross dimension.

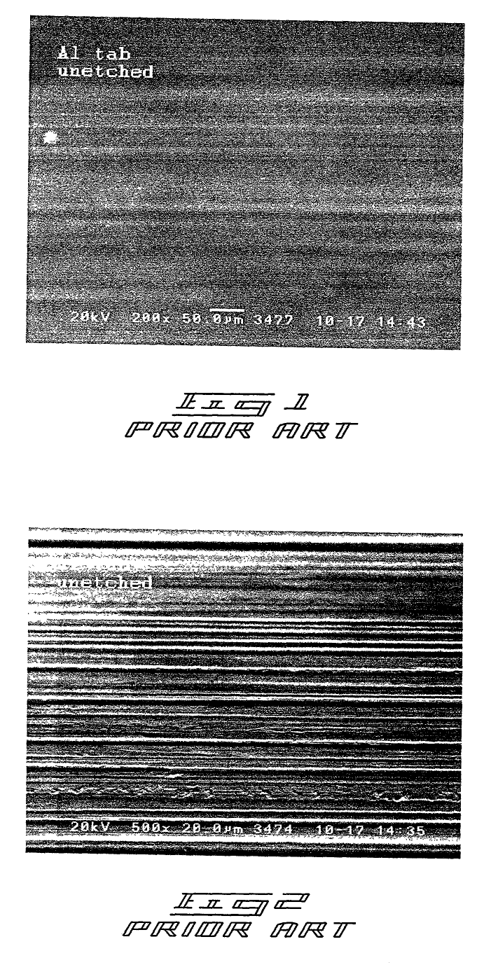

FIGS. 1 and 2 are prior art 20 kV photomicrographs taken at normal and oblique angles, and at magnification levels of 200 times and 500 times, respectively, of a prior art aluminum cathode terminal member which does not have an outer rough surface characterized in accordance with any aspect of the invention. By way of example only, such depicts a plurality of longitudinally and parallel-extending ridges the largest of which are 3 microns to 5 microns high, the smallest of which are less than 1 micron high. Such were determined to extend, and this have a maximum cross dimension of, more than 500 microns in length.

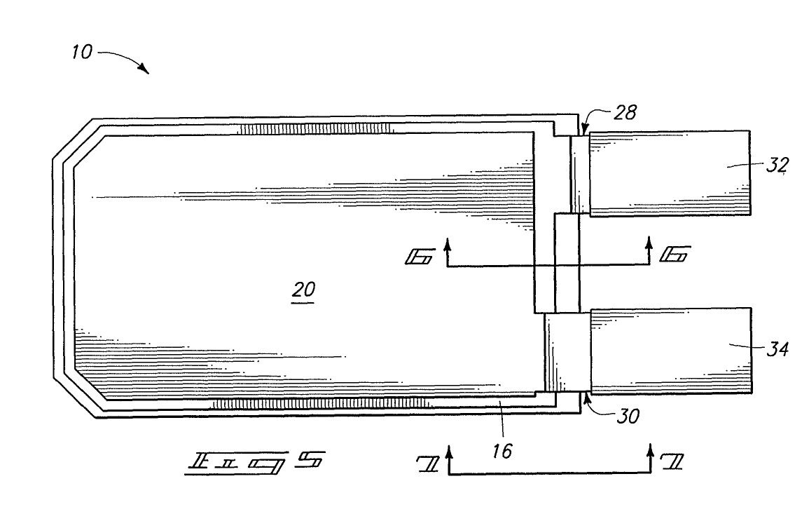

FIGS. 3 and 4 are normal and oblique angle photomicrographs at the same power and magnifications of FIGS. 1 and 2 of an exemplary aluminum cathode terminal member having an outer surface characterized in accordance with at least one aspect of the invention. Such depicts, in but one example, the surface nodules referred to above.

One preferred method of providing at least one aspect of the characterized rough outer surface includes roughening outer surfaces of a continuous web of terminal member material prior to cutting into individual terminal members. One preferred roughening technique includes brushing the outer surface, preferably with rotary action using brushes having brush bristles which are of harder material than the terminal member material surface being roughened. For example and by way of example only with respect to the aluminum and copper tab materials, exemplary brush bristles include full hard austenitic or ferritic stainless steel material. An example bristle length is 20 mm, and an example downward pressure is 1 Newton/mm².

An alternate form of roughening comprises chemical etching of the outer surface. For example with respect to aluminum, an example aluminum etchant capable of roughening the outer surface to be characterized in accordance with at least one aspect of the invention is a 1M to 6M aqueous potassium hydroxide solution. An exemplary etching chemistry for copper includes a 1M to 6M aqueous hydrochloric acid solution. Another rat alternate roughening technique comprises electrochemical etching the outer surface. Exemplary techniques for copper and aluminum include electrodissolution, followed by surface repassivation by way of an acid, such as 1M to 6M chromic acid or an equivalent organic acid (e.g., oxalic acid).

Yet another example roughening technique includes deposition of a material on the outer surface. By way of example only, such could include electrodepositing.

By way of example only, further roughening examples include abrasion with an abrasive, abrasion by ultrasonic or other waves, and blasting with an abrasive. The preferred and reduction-to-practice example comprises brushing, and particularly rotary brushing with a brush having bristles which are harder than the material of the outer surface being brushed.

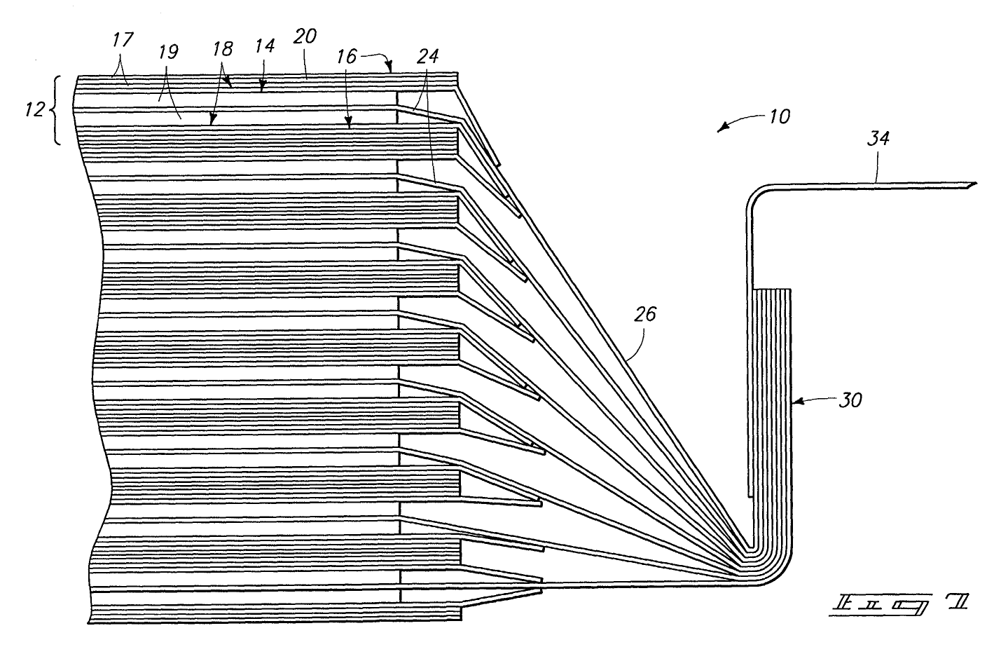

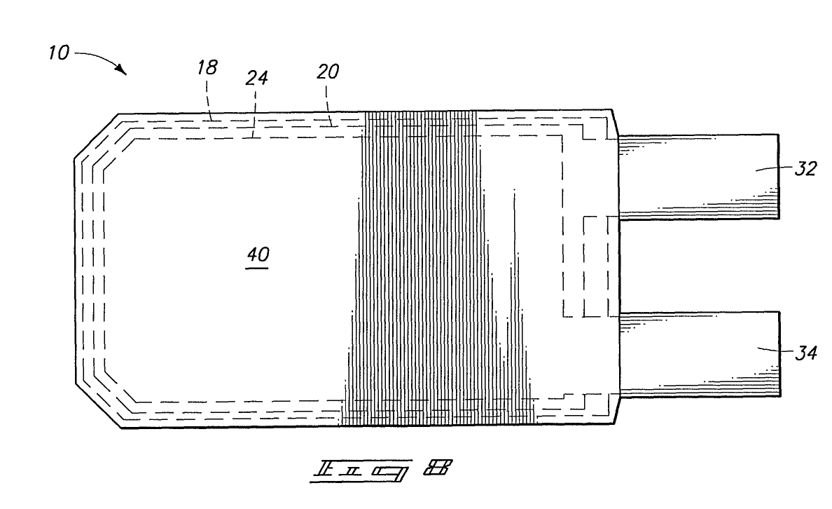

After roughening, the respective terminal members 32, 34 are preferably cut to their desired length, welded with the respective current collector extension tabs 28, 30 and folded as shown in FIGS. 6 and 7.

Referring to FIG. 8, and after the adhering, the battery components are enveloped in any suitable housing 40 (also comprising a suitable electrolyte therein) comprising electrically insulative material with at least one terminal member, and preferably two as shown, projecting therefrom. A preferred housing material comprises a laminate construction of polyester, adhesive, aluminum, ethylene acrylic acid adhesive, low density polyethylene and acrylic acid layers. The enveloping preferably comprises providing the battery apparatus components between two sheets of the laminate. Then, some of the electrically insulative material of the housing 40 is caused to flow onto the rough surface, typically and preferably by application or generation of heat to cause at least partial melting of the insulative material of the housing by existing or yet-to-be developed techniques. For example, heat welding, ultrasonic welding or chemical welding may be used.

The preferred embodiment electrically insulative housing material thereby contacts and bonds with the outer rough surface, forming a complete seal. In other words, there are no gaps between the expanded surface area of the rough surface and the electrically insulative material where these components are not adhered to each other. In addition, the seal extends preferably continuously around the extension. Thus, a preferred result is an improved mechanical and chemical seal of the housing to the terminal members to form an overall improved hermetic seal.

The above preferred embodiment was in connection with a battery apparatus comprising a plurality of bicells, although the invention is in no way so limited. For example, and by way of example only, the invention contemplates methods and apparatus associated with any existing or yet-to-be developed battery apparatus having one or more anode layers, cathode layers and electrolyte layers, and one or more anode and cathode assemblies.

1. A battery apparatus comprising:
an anode layer, a cathode layer, and an electrolyte operatively positioned therebetween;
a housing comprising electrically insulative material enveloping and sealed around the anode layer, the cathode layer and the electrolyte;
an anode terminal electrically connected with the anode layer and a cathode terminal electrically connected with the cathode layer, the anode terminal and the cathode terminal being electrically accessible externally of the housing; and
at least one of the anode terminal and the cathode terminal having an electrically conductive extension extending through and contacting the electrically insulative housing material, the extension having a rough surface in contact with the electrically insulative housing material, the rough surface being shaped such that a complete seal around the electrically conductive extension may be provided between the rough surface of the electrically conductive extension and the insulative housing material; and
a bond providing a complete seal continuously around the electrically conductive extension between the rough surface of the electrically conductive extension and the insulative housing material.

2. A battery apparatus according to claim 1, wherein the electrically conductive extension is a separate component from the anode layer or the cathode layer which is adhered to the anode layer or cathode layer.

3. A battery apparatus according to claim 1, wherein the anode layer, the cathode layer, and the electrolyte operatively positioned therebetween includes a plurality of the anode layers, the cathode layer and the electrolyte arranged to form a plurality of bicells.

4. A battery apparatus according to claim 1, wherein both the anode terminal and the cathode terminal each have an electrically conductive extension extending through and contacting the electrically insulative housing material, each extension having a rough surface in contact with the electrically insulative housing material, each of the rough surfaces being shaped such that a complete seal continuously around each of the electrically conductive extensions may be provided between the rough surface of the electrically conductive extension and the insulative housing material, and wherein a bond provides a complete seal continuously around the electrically conductive extension between the rough surface of each of the electrically conductive extensions and the insulative housing material.

5. A battery apparatus according to claim 4, wherein the anode layer, the cathode layer, and the electrolyte operatively positioned therebetween includes a plurality of the anode layers, the cathode layer and the electrolyte arranged to form a plurality of bicells.

6. A battery apparatus according to claim 1, wherein the rough surface includes a plurality of surface nodules which contact and bond with the enveloping electrically insulative housing material, (i) at least a majority of the surface nodules, and/or (ii) at least 25 of the surface nodules within a 50,000 micron² area and/or (iii) an average of all surface discernable objects along any 500 micron length of the rough surface, having a height which is at least about 5 microns and having a maximum cross dimension which is at least 20 microns.

7. A battery apparatus according to claim 6, wherein the height is from about 10 microns to about 25 microns.

8. A battery apparatus according to claim 6, wherein the height is from about 12 microns to about 20 microns.

9. A battery apparatus according to claim 6, wherein the maximum linear cross dimension is less than about 100 microns.

10. A battery apparatus according to claim 6, wherein the maximum linear cross dimension is from about 30 microns to about 80 microns.

11. A battery apparatus according to claim 6, wherein the height is from about 10 microns to about 25 microns, and the maximum linear cross dimension is from about 30 microns to about 80 microns.

12. A battery apparatus comprising:
an anode layer, a cathode layer, and an electrolyte operatively positioned therebetween;
a housing comprising electrically insulative material enveloping and sealed around the anode layer, the cathode layer and the electrolyte;
an anode terminal electrically connected with the anode layer and a cathode terminal electrically connected with the cathode layer, the anode terminal and the cathode terminal being electrically accessible externally of the housing; and
at least one of the anode terminal and the cathode terminal having an electrically conductive extension extending through and contacting the electrically insulative housing material, the extension having at least one outer rough surface including a plurality of surface nodules which contact and bond with the enveloping electrically insulative housing material, (i) at least a majority of the surface nodules, and/or (ii) at least 25 of the surface nodules within a 50,000 micron² area and/or (iii) an average of all surface discernable objects along any 500 micron length of the rough surface, having a height which is at least about 5 microns and having a maximum cross dimension which is at least 20 microns.

13. A battery apparatus according to claim 12, wherein the height is from about 10 microns to about 25 microns.

14. A battery apparatus according to claim 12, wherein the height is from about 12 microns to about 20 microns.

15. A battery apparatus according to claim 12, wherein the maximum linear cross dimension is less than about 100 microns.

16. A battery apparatus according to claim 12, wherein the maximum linear cross dimension is from about 30 microns to about 80 microns.

17. A battery apparatus according to claim 12, wherein the height is from about 10 microns to about 25 microns, and the maximum linear cross dimension is from about 30 microns to about 80 microns.

18. A battery apparatus according to claim 12, wherein the anode layer, the cathode layer, and the electrolyte operatively positioned therebetween includes a plurality of the anode layers, the cathode layer and the electrolyte arranged to form a plurality of bicells.

19. A method of forming a battery apparatus having an anode, a cathode and an electrolyte therebetween, the method comprising the steps of:
providing an outer surface of at least one of an anode terminal material and a cathode terminal material with a rough surface;
enveloping the anode, the cathode and the electrolyte in a housing comprising electrically insulative material;
extending at least one of the anode terminal material and the cathode terminal material through the housing such that the at least one terminal material projects therefrom; and
bonding the electrically insulative material to the rough surface by flowing the electrically insulative housing material onto the rough surface to form a complete seal between the rough surface of the terminal and the electrically insulative housing material.

20. A method according to claim 19, wherein the step of bonding to form a complete seal includes providing the complete seal continuously around the electrically conductive extension between the rough surface of the terminal and the electrically insulative housing material.

21. A method according to claim 19, wherein the step of bonding by flowing includes melting by at least one of the steps selected from the group consisting of heat welding, ultrasonic welding and chemical welding.

22. A method according to claim 20, wherein the step of bonding by flowing includes melting by at least one of the steps selected from the group consisting of heat welding, ultrasonic welding and chemical welding.

23. A method according to claim 19, wherein the step of providing at least one of the anode terminal material and a cathode terminal material with a rough surface adhering the at least one of the anode terminal material and the cathode terminal material with a rough surface to another component of the anode or the cathode.

24. A method according to claim 20, wherein the step of providing at least one of the anode terminal material and a cathode terminal material with a rough surface adhering the at least one of the anode terminal material and the cathode terminal material with a rough surface to another component of the anode or the cathode.

25. A method according to claim 19, wherein the step of providing an outer surface with a rough surface includes at least one of the steps selected from the group consisting of brushing of the outer surface, chemical etching of the outer surface, abrading with an abrasive, and depositing a material on the outer surface.

26. A method according to claim 19, wherein the step of providing an outer surface with a rough surface includes at least one of the steps selected from the group consisting of rotary brushing of the outer surface, electrochemical etching of the outer surface, and electrodepositing a material on the outer surface.

27. A method according to claim 19, wherein the step of providing an outer surface with a rough surface includes providing a plurality of surface modules, (i) at least a majority of the surface modules; and/or (ii) at least 25 of the surface modules within a 50,000 micron² area; and/or (iii) an average of all surface discernable objects along any 500 micron length of rough surface; with a height which is at least about 5 microns and with a maximum cross dimension which is at least 20 microns.

28. A method of forming a battery apparatus having an anode layer, a cathode layer, and an electrolyte operatively positioned therebetween, the method comprising the steps of:
enveloping the anode layer, the cathode layer and the electrolyte in a housing comprising electrically insulative material;
extending an anode terminal electrically connected with the anode layer and a cathode terminal electrically connected with the cathode layer through the housing such that at least one terminal material projects therefrom;
providing an outer surface of at least one of the anode terminal and the cathode terminal with a plurality of surface nodules such that, (i) at least a majority of the surface nodules, and/or (ii) at least 25 of the surface nodules within a 50,000 micron² area and/or (iii) an average of all surface discernable objects along any 500 micron length of the rough surface, have a height which is at least about 5 microns and have a maximum cross dimension which is at least 20 microns; and
bonding the electrically insulative material to the rough surface.

29. The method according to claim 28, wherein the surface nodules are provided such that the height is from about 10 microns to about 25 microns.

30. The method according to claim 28, wherein the surface nodules are provided such that the height is from about 12 microns to about 20 microns.

31. The method according to claim 28, wherein the surface nodules are provided such that the maximum linear cross dimension is less than about 100 microns.

32. The method according to claim 28, wherein the surface nodules are provided such that the maximum linear cross dimension is from about 30 microns to about 80 microns.

33. The method according to claim 28, wherein the surface nodules are provided such that the height is from about 10 microns to about 25 microns, and the maximum linear cross dimension is from about 30 microns to about 80 microns.

34. A method according to claim 28, wherein the step of providing an outer surface with a rough surface includes at least one of the steps selected from the group consisting of brushing of the outer surface, chemical etching of the outer surface, abrading with an abrasive and depositing a material on the outer surface.

35. A method according to claim 28, wherein the step of providing an outer surface with a rough surface includes at least one of the steps selected from the group consisting of rotary brushing of the outer surface, electrochemical etching of the outer surface, a and electrodepositing a material on the outer surface.

36. A method according to claim 19, wherein the step of bonding includes providing a complete seal continuously around the electrically conductive extension between the rough surface of the terminal and the electrically insulative housing material.
